(19) United States
(12) Patent Application Publication
(10) Pub. No.: US 2021/0276263 A1
(43) Pub. Date: Sep. 9, 2021

(54) METHOD AND DEVICE FOR PRODUCING A THREE-DIMENSIONAL OBJECT

(71) Applicant: ENSINGER GmbH, Nufringen (DE)

(72) Inventors: Michael MÖLLER, Cham (DE); Dominik SCHWEIGER, Chamerau (DE)

(21) Appl. No.: 16/338,980

(22) PCT Filed: Oct. 12, 2017
(86) PCT No.: PCT/IB2017/056303

§ 371 Date: Apr. 2, 2019

(30) Foreign Application Priority Data
Oct. 21, 2016 (DE) 102016120098.0

(51) Int. Cl. B29C 64/393; B29C 64/106; B29C 64/295; B33Y 10/00; B33Y 30/00; B33Y 50/02; B33Y 70/00

(52) U.S. Cl. CPC B29C 64/393; B29C 64/106; B29C 64/295; B29K 2071/00; B33Y 30/00; B33Y 50/02; B33Y 70/00; B33Y 10/00

(57) ABSTRACT

The invention relates to a method and a device (1) for the additive manufacturing of a three-dimensional object (2) from a high-temperature polymer material. The method comprises the steps of plasticating a high-temperature polymer material above the melting temperature (TS) of the high-temperature polymer material, and cooling the plasticated high-temperature plastic to a processing temperature (TV) which lies above a crystallization temperature (TK) of the high-temperature plastic and which lies below a permissible temperature maximum value (TL) of the critical device components within a device (1) for the additive manufacturing of the three-dimensional object (2) from the high-temperature polymer material or below the melting temperature (TS) of the high-temperature polymer material. This is followed by the additive manufacturing of the three-dimensional object (2) from the plasticated high-temperature polymer material cooled to the processing temperature. The device (1) is designed to carry out the method and, for this purpose, comprises means (3) for plasticating the high-temperature polymer material, means (4) for cooling the plasticated high-temperature polymer material and means (10) for conveying the melt of the high-temperature polymer material which has been cooled to the processing temperature (TV) into means (5) for the additive manufacturing of the three-dimensional object (2).

### FIELD OF THE INVENTION

The present invention relates to a method and a device for manufacturing a three-dimensional object. In particular, the invention relates to a method and a device for the additive manufacturing of a three-dimensional object out of a high-temperature polymer material (three-dimensional printing).

### TECHNOLOGICAL BACKGROUND

Three-dimensional objects made out of polymer materials can be manufactured in large numbers, e.g., via casting or injection molding in molding tools or via the extrusion, corrugation, or machining/ablative processing of semi-finished products. In the injection molding process, complex geometries of the polymer material parts can be realized precisely and in a fast cycle time. However, this always requires the construction of a high-priced injection molding tool specifically configured for the part geometry, which as a rule only pays off at high quantities. Small series or individual parts, e.g., sample parts or high-priced custom products with short-term delivery requirements, are typically manufactured using manufacturing methods such as the machining of semi-finished products or additive production methods. Additive production methods, which include “three-dimensional printing” (hereinafter abbreviated to “3D-printing”), enable the so-called rapid prototyping or rapid manufacturing, i.e., the direct manufacture of design of product samples, as well as of products or intermediate products from a digital drawing without tools specifically configured for their part geometry. 3D-printing can also be used for making geometrically highly complex parts and structures, which were not accessible with previous manufacturing processes, and enable new functionalities.

It is known to plasticize polymer materials in the form of plastic granules or filaments by melting in a method for three-dimensional printing. For example, plasticizing can take place in a heated plasticizing extruder (cylinder with a plasticizing screw) known from injection molding, as a result of which a polymer material melt is produced. A print head or discharge unit with a nozzle can be used to discharge the polymer material melt under pressure in fibers, drops, points, lines or layers onto provided locations on a three-dimensional object carrier capable of computer-controlled movement, which once the discharged polymer material melt has hardened results in an envisaged three-dimensional object. One example of a device suitable for such a method is the commercial “Freeformer” type 3D-printer from Arburg GmbH & Co KG, which was introduced in 2013. Likewise known are devices in which the object carrier is static, while the print head is mobile, e.g., the commercial “Delta Tower” type 3D-printer from Delta Tower GmbH.

For example, carrying out a 3D-printing process by discharging and/or depositing fine drops or fibers results in various technical challenges. In order to produce defined, fine drops, a high pressure and adjusted processing temperature are required, so as to adjust the viscosity of the melted polymer material for the discharge unit. Devices known from prior art that are set up to carry out a three-dimensional printing process described above by outputting finely dosed, plasticized melt usually have a device-specific temperature limit for the polymer melt. This temperature limit is intended to prevent damages or elevated wear on device components, or procedural problems. An especially temperature-critical component of the printing device is here the print head or discharge unit, which can become damaged at high temperatures, depending on the model. The thermal warping (thermal expansion) of device components at high temperatures along with—concurrently—pronounced temperature gradients also represents a problem. Among other things, an uncontrolled thermal expansion can result in a warping, twisting or jamming of mechanical parts, which temporarily or permanently impairs the printing process.

Therefore, observing a temperature limit protects in particular the print head or discharge unit of the device. Due to the variety of possible designs of 3D-printers, there may exist temperature limits that vary from device to device. Likewise, it is possible that various device components or assemblies within a 3D printer have different temperature limits.

When processing high-temperature plastics, e.g., specific polyphthalamides (PPA, e.g., PA6T/X), polyphenylene sulfide (PPS) or polyaryletherketones (PAEK) like polyetherketone (PEK) or polyetheretherketone (PEEK), the temperature limit of known devices is usually exceeded, since the high-temperature plastics for plasticizing and discharging are heated even more distinctly above their already high melting point, so as to achieve a desired viscosity for the melt, and thereby make the melt processable. For example, the melting point for PEEK lies at 341° C. In the present context, high-temperature polymer materials are polymers, polymer blends or polymer compounds that consist of at least one partially crystalline high-temperature plastic or contain at least one partially crystalline high-temperature plastic. Depending on the intended application and field of use for the product, they can also contain additives, fillers, dyes or pigments. Partially crystalline high-temperature plastics are here characterized by a melting point of above 300° C., preferably of above 280° C., and especially preferably of above 250° C.

It is obvious that instrumental modifications of the 3D-printer, the redesign of device components and/or the use of components that can be exposed to high temperatures (above all cables, hoses, hinges, motors, switches, sensors, electronic parts, piezo elements, etc.) enable a structural solution to the problem. However, this variant is not preferred, among other things due to the high costs.

### SUMMARY OF THE INVENTION

The object of the present invention is to provide a method and a device of the kind mentioned at the outset, which enable a three-dimensional printing of an object out of a high-temperature plastic, which in the interim is converted into a plasticized state without in the process exceeding device- or assembly-specific temperature limits of the 3D-printer.

The object is achieved by the subject matter of the independent claims. Advantageous embodiments are the subject matter of the subclaims, the following specification and the figures.

A first aspect of the invention provides a method for the additive manufacturing of a three-dimensional object out of a high-temperature polymer material. The method initially starts out with plasticizing a polymer material, which yields a melt of the high-temperature polymer material. For example, plasticization can take place in a known manner using a plasticizing extruder, which without any problem can be configured for higher temperatures, i.e., in particular for temperatures above a temperature limit T_{L} for temperature-critical components, e.g., a print head or a discharge unit. Plasticization takes place at a plasticization temperature T_{P} above the melting temperature T_{S} of the high-temperature polymer material.

As the expert is aware, a plastic melt can be plasticized and conveyed not only by means of a plasticizing extruder. Contact heaters (heatable melt containers, nozzles or channels), microwave-, UV- or infrared-radiation, along with coherent radiation (lasers) can likewise be used for melting purposes. The expert further recognizes that the polymer material(s) can be provided not just in granule form. Likewise suitable are delivery forms such as powders, filaments, films, fibers or inhomogeneous particles like ground material. The melt resulting from plasticization can be conveyed by applying an excess pressure, e.g., of a protective gas, or via mechanical pumps, e.g., gear pumps, cylinder syringes or reciprocating pumps.

The plasticized high-temperature polymer material is cooled to a processing temperature T_{V} lying above a crystallization temperature T_{K}, but below the melting temperature T_{S} of the high-temperature polymer material. Furthermore, the processing temperature T_{V} lies below a permissible maximum temperature value T_{L} of at least one critical device component of a device, in particular of a 3D-printer, for the additive manufacturing of the three-dimensional object out of the high-temperature polymer material, in particular below a temperature limit T_{L} of a print head or a discharge unit of the device.

The melt of the high-temperature polymer material cooled to the processing temperature T_{V} is then conveyed in means for the additive manufacturing of the three-dimensional object out of the plasticized high-temperature polymer material cooled to the processing temperature T_{V}. The means for additively manufacturing the three-dimensional object can in particular comprise a discharge unit, a print nozzle or a 3D print head. In addition, the three-dimensional object is additively manufactured out of the plasticized high-temperature polymer material cooled to the processing temperature T_{V} using the means for the additive manufacturing of the three-dimensional object, in particular using the 3D-print head or using the discharge unit.

Processing or additively manufacturing the three-dimensional object here refers in particular to printing or discharging the melt. The independently running process of cooling and crystallizing the discharged or deposited polymer melts on the final position in the component does constitute processing in this sense.

Mathematically expressed, the melting temperature T_{S}, crystallization temperature T_{K}, processing temperature T_{V}, maximum temperature value T_{L} and plasticization temperature T_{P} correlate as follows:
T_{K}<T_{V}<T_{L}<T_{S}<T_{P}.

In other words, the plasticized polymer melt is cooled to a temperature value T_{V} that lies below the melting temperature or plasticization temperature T_{P}, and lies between the crystallization temperature T_{K} and permissible maximum temperature value T_{L} of the device (temperature limit), and is then brought to the cooled temperature value T_{V}, so as to form the three-dimensional object.

In prior art, the following scenario is usually encountered:
T_{K}<T_{S}<T_{V}˜T_{P}<T_{L} or T_{K}<T_{S}<T_{V}<T_{P}<T_{L}.

As a rule, a single temperature limit T_{L} is here considered for the complete device, and this temperature limit T_{L} lies above the processing temperature. This can be realized by using only low-temperature melting polymer materials, or by making the 3D-printer resistant to high temperatures. Processing here takes place at above the melting temperature.

The melt does not yet solidify when approaching the processing temperature T_{V} proceeding from T_{P}, because this only takes place at the crystallization point or given a drop below the crystallization temperature T_{K}, which can lie distinctly below the melting temperature and below the temperature limit T_{L} of the device. The position of the crystallization temperature is changeable, wherein the crystallization can be specifically adjusted/set using the device and method parameters (e.g., shearing rate, orientation of polymer chains), additivation (e.g., nucleation) or interventions in the polymer chemistry (e.g., chain length, degree of branching, composition).

Cooling of the melt can take place with means for cooling and tempering suitable for this purpose, and should be controlled. Suitable methods and accompanying means for specifically cooling a melt and optionally keeping it at a cooled temperature are known to the expert. These can be active or passive cooling methods, e.g., with media cooling (air, liquid) or electric cooling (Peltier, etc.). Likewise, it is advantageously provided that the cooling process be actively controlled and/or monitored by sensors. The cooling process described above allows in particular the temperature-critical components of a 3D-printer to come into contact with a plasticized polymer material without becoming damaged. The method according to the invention thus makes it possible to also use high-temperature polymer materials in 3D-printing processes without having to specially configure the printing technology for high temperatures, and without exceeding a temperature limit T_{L} for a device to be used in the process.

For example, a suitable temperature range between the crystallization temperature T_{K} and temperature limit T_{L} can be roughly determined through DSC measurements. In order to be able to avoid damage to the device in an especially reliable manner, the selected processing temperature T_{V} can be very close to the crystallization temperature T_{K}, but must not drop below it. In order to prevent the melt from solidifying prematurely in this case, possible relevant temperature fluctuations in the machine components of the device along with effects like shear-induced crystallizations are determined, and the temperature control of the melt is adjusted accordingly. As described above, the processing temperature T_{V} preferably lies below the melting temperature T_{S} of a high-temperature polymer material.

Therefore, one major advantage to this method according to the invention is the ability to print high-temperature polymer materials, wherein the use of expensive and complex high-temperature modifications to printer technology and printer mechanics can be completely or partially avoided. As a consequence, this distinctly lowers the overall costs for such printing methods. Other significant advantages are obtained from the lower temperature of the polymer melt: Since less heat (thermal energy) is transferred to the component by the cooled melt, there is a lower tendency toward warping, which can be easily computationally derived from the temperature difference (e.g., the difference between the temperature of the deposited polymer melt and room temperature or the temperature at which the printed object is used) and the thermal expansion coefficient, or in the melt, from the volume expansion coefficient of the polymer material. The solidification of the printed layer is likewise accelerated, and the thermal damage to the material is reduced. This all helps to enhance the quality of a printed object.

An embodiment advantageously provides that the high-temperature polymer material be a polymer, polymer blend or polymer compound, which consists of at least one partially crystalline high-temperature plastic, or contains at least one partially crystalline high-temperature plastic, wherein the partially crystalline high-temperature plastic is characterized by a melting point of above 260° C. In particular, the melting point can lie above 300° C., preferably above 280° C., especially preferably above 250° C. The high-temperature plastic further preferably contains additives, fillers, dyes or pigments.

It is further advantageously provided that the partially crystalline high-temperature plastic be a polyaryletherketone (PAEK), a polyphthalamide (PPA), a polyamide (PA), polyphenylene sulfide (PPS), syndiotactic polystyrene (sPS) or a liquid crystalline polymer (LCP). Also preferred are polyetherketone (PEK), polyetheretherketone (PEEK) and partially aromatic polyamide, e.g., PA6T/X.

In another embodiment, the high-temperature polymer material is a polyetheretherketone (PEEK), preferably an unmodified polyetheretherketone, or contains at least one polyetheretherketone, wherein a melting temperature T_{S} can lie at 341° C. The high-temperature polymer material is plasticized at a temperature of 345° C. to 400° C., preferably at 360° C. to 390° C. In this embodiment, the plasticized polyetheretherketone is further cooled to a processing temperature T_{V} of between 305° C. and 335° C. directly after plasticization, but before conveyed further in temperature-critical device assemblies. The melt of the high-temperature polymer material cooled to the processing temperature T_{V} is then conveyed in particular into a discharge unit or a print nozzle, and the three-dimensional object is additively manufactured out of the polyetheretherketone plastic cooled to the processing temperature T_{V}. The crystallization temperature of the polyetheretherketone plastic here lies between 290° C. and 300° C. according to the DSC.

It can further be advantageously provided that the high-temperature polymer material is present in a low-viscous configuration. This low viscosity of the melt can here be set in particular via the molecular mass distribution of the polymer/polymers, polymer architecture and/or additivation in such a way that the high-temperature polymer material present at the processing temperature T_{V} can be discharged via the print nozzle or via the discharge unit. In particular, this makes it possible to counteract the problem that cooling generally causes the viscosity inside of plastics to increase. In particular “injection molding types” known in the art can here be used in particular as the low-viscosity, high-temperature plastics or polymer materials, which by comparison to higher- or high-viscosity “extrusion” or “compounding” types tend to be characterized by a lower average molecular weight and/or are additivated with glide agents or lubricants.

In another embodiment, the method according to the invention further involves cleaning the temperature-critical components by removing plasticized, high-temperature polymer material cooled to the processing temperature T_{V}. This can take place according to plan after a print job has concluded, or prematurely given a planned or unplanned interruption of a print job. The cleaning process involves rinsing with a neutral plastic or a suitable cleaning material, which can be provided in the form of granules, filaments and the like, and is also plasticized. In other words, should any residual plasticized melt of the high-temperature polymer material still be located inside a device for implementing the method according to the invention after the object has been manufactured as described above, and should the device be in a so-called neutral mode, for example, in which the device is paused, the cooled residual melt can be removed in a controlled manner before problems arise. Device components can be cleaned after a planned or unplanned crystallization or cooling of the polymer melt in the printing device with suitable solvents or using physical or mechanical processes. For example, removable device components can be effectively cleaned in pyrolytic processes or in cleaning baths, through ultrasound, brushes or similar cleaning means. It is likewise possible to use blasting processes, e.g., with dry ice, sand, metal or ceramic particles, above all stainless steel and corundum or hard shells.

A further embodiment also provides that the means for cooling the plasticized, high-temperature polymer material to the processing temperature T_{V} be electronically regulated, wherein, during the cooling, conveying and additive manufacturing process, the temperature of the plasticized, high-temperature polymer material is preferably continuously monitored, and the cooling means are electronically regulated in such a way that the plasticized, high-temperature polymer material always has a temperature above the crystallization temperature T_{K}. Monitoring can here involve in particular measuring the temperatures of the plasticized, high-temperature polymer material by means of a sensor provided for this purpose, comparing them with stored temperature values, and drawing a conclusion from the comparison, wherein the conclusions make it possible to derive, introduce and implement measures as to how cooling is to be continued.

For example, depending on the received temperature values, a cooling capacity of the cooling means can be increased, the cooling capacity can be decreased, or cooling can be completely discontinued (“cooling capacity equals zero”). In addition, for example, given a detected excessively rapid cooling of the plasticized, high-temperature polymer material or determined temperatures lying too close to the crystallization temperature T_{K}, it can be provided that the high-temperature polymer material be (re)heated, e.g., by means of additional means suitably configured for heating the plasticized, high-temperature polymer material. A suitably configured electronic regulating unit can be used to control the temperature sensor, compare the temperatures, draw conclusions and derive, introduce and implement (to include control and regulate) countermeasures. This embodiment helps to especially reliably be able to prevent the plasticized, high-temperature polymer material from solidifying in the area of the cooling means and/or in the area of the additive manufacturing means, in particular in the area of the 3D-print head.

A second aspect of the invention provides a device for additively manufacturing a three-dimensional object out of a high-temperature polymer material. The device is configured to implement a method according to the first aspect of the invention. For this purpose, the device has means for plasticizing the plasticized, high-temperature polymer material above the melting temperature T_{S} of the high-temperature polymer material, e.g., an in itself known plasticizing extruder, which can be smoothly configured for higher temperatures, in particular above the temperature limits T_{L} described above.

The device further comprises means for cooling the high-temperature polymer material to a processing temperature T_{V} described above, which lies above a crystallization temperature T_{K} of the high-temperature polymer material, and which lies below a maximum temperature value T_{L} for the critical device components within the device, wherein the cooling means are preferably configured to keep the high-temperature polymer material at the processing temperature T_{V}, and the processing temperature T_{V} preferably lies under the melting temperature (T_{S}) of the high-temperature polymer material.

The device further comprises means for conveying the melt of the high-temperature polymer material cooled to the processing temperature T_{V} to means for additively manufacturing the three-dimensional object out of the plasticized, high-temperature polymer material cooled to the processing temperature T_{V} and preferably kept at the processing temperature T_{V}. In particular, the conveying means can be means that generate an excess pressure, e.g., with the use of a protective gas, or a mechanical pump, e.g., a gear pump or a reciprocating pump. In particular, the additive manufacturing means can be a discharge unit, a print nozzle or a 3D-print head.

In an embodiment, the plasticizing means are configured to plasticize a polyetheretherketone polymer material or a polyetheretherketone plastic at a temperature of 345° C. to 400° C., preferably at a temperature of between 360° C. and 390° C. Furthermore, the cooling means are configured to cool the plasticized polyetheretherketone polymer material to a processing temperature of between 305° C. and 335° C., and preferably to keep it in this temperature range. The crystallization temperature of the polyetheretherketone plastic here lies between 290° C. and 300° C. according to the DSC. The layered manufacturing means are further configured to additively manufacture the three-dimensional object out of the polyetheretherketone polymer material cooled to the processing temperature and preferably kept in this temperature range.

In another embodiment, the device further has an electronic regulating unit, which is configured to electronically regulate the means for cooling the plasticized high-temperature polymer material to the processing temperature T_{V}, wherein, during the cooling, conveying and additive manufacturing process, the temperature of the plasticized high-temperature polymer material is preferably continuously monitored, and the cooling means are electronically regulated in such a way that the plasticized, high-temperature polymer material always has a temperature above the crystallization temperature T_{K}. In particular, monitoring can here involve measuring the temperatures of the plasticized, high-temperature polymer material by means of a sensor configured for this purpose, comparing them with stored temperature values, and drawing a conclusion from the comparison, wherein the conclusions make it possible to derive, introduce and implement measures as to how cooling is to be continued.

For example, depending on the received temperature values, a cooling capacity of the cooling means can be increased, the cooling capacity can be decreased, or cooling can be completely discontinued (“cooling capacity equals zero”). In addition, for example, given a detected excessively rapid cooling of the plasticized, high-temperature polymer material or determined temperatures lying too close to the crystallization temperature T_{K}, it can be provided that the high-temperature polymer material be (re)heated, e.g., by means of additional means suitably configured for heating the plasticized, high-temperature polymer material.

The electronic regulating unit is configured to control the temperature sensor for performing the temperature measurements as described above. The electronic regulating unit is further configured to control the aforementioned process of comparing, concluding and deriving, introducing and implementing (to include controlling or regulating) countermeasures. This embodiment helps to especially reliably be able to prevent the plasticized, high-temperature polymer material from solidifying in the area of the cooling means and/or in the area of the additive manufacturing means, in particular in the area of the 3D-print head.

Melting and crystallization temperatures can be easily determined, e.g., through DSC measurements (differential scanning calorimetry). Common processes, such as determining the peak temperature or onset temperatures, can be found among other places in Praxis der thermischen Analyse von Kunststoffen (Practice of Thermally Analyzing Plastics); Ehrenstein, G. W.; Riedel, G.; Trawiel, P.; Hanser Verlag 1998; ISBN 3-446-21001-6.

Temperature limits for devices are specified by device manufacturers or component manufacturers, or can be determined in tests under a temperature load. The temperature limit is here to indicate a limit that enables a reliable operation of the printing device as a whole or parts (components) thereof, without the components incurring any sustained damage or sustained changes.

### BRIEF DESCRIPTION OF THE FIGURES

Exemplary embodiments of the invention will be explained in more detail below based on the schematic drawing. Shown here on:

FIG. 1 is a side view of an exemplary embodiment of a device according to the invention for additively manufacturing a three-dimensional object out of a high-temperature polymer material;

FIG. 2 is a flowchart of an exemplary embodiment of a device according to the invention for additively manufacturing a three-dimensional object out of a high-temperature polymer material.

### DETAILED DESCRIPTION OF EXEMPLARY EMBODIMENTS

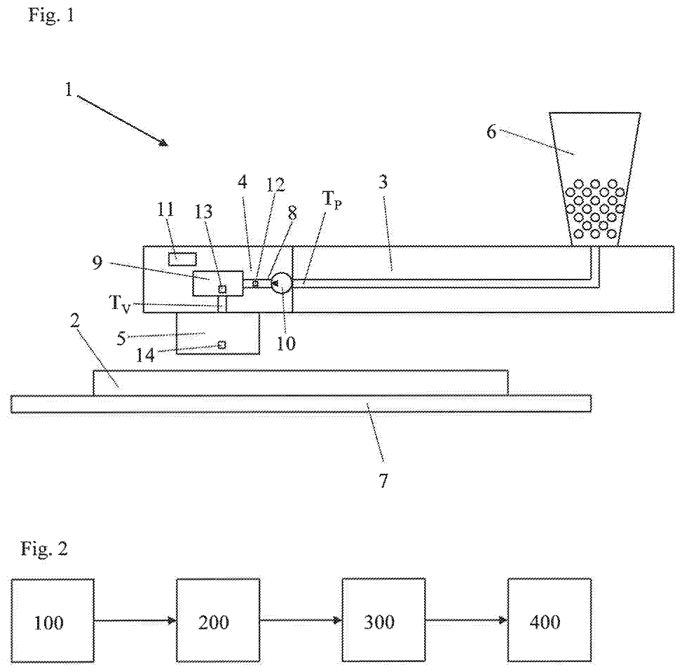

FIG. 1 shows a device 1 for additively manufacturing a three-dimensional object 2 out of a high-temperature polymer material. The device 1 is a 3D-printer, which has means 3 for plasticizing the high-temperature polymer material, means 4 for cooling the plasticized, high-temperature polymer material to a processing temperature, as well as means 5 for additively manufacturing a three-dimensional object 2. The 3D-printer 1 further has a granule container 6 and an object carrier 7 for the object 2.

In the exemplary embodiment shown on FIG. 1, the plasticizing means 3 involve a plasticizing extruder. The high-temperature polymer material is located in the granule container 6 in granule form. The granule container 6 is connected with the plasticizing extruder 3 in such a way that granules can be automatically fed from the granule container 6 to the plasticizing extruder 3, which is configured to increase the temperature of the granules supplied to it to a plasticizing temperature T_{P} above a melting temperature T_{S} of the granules, and thereby convert them into a polymer material melt.

The plasticizing extruder 3 can further feed the polymer material melt to the cooling means 4 in particular under pressure. For example, the cooling means 4 can comprise a channel 8 that can be controllably cooled with an electronic regulating unit 11, through which the polymer material melt is guided as it exits the plasticizing extruder 3 into the layered manufacturing means 5. As it passes through the channel 8, the temperature of the polymer material melt can be lowered to a processing temperature T_{V} lying above a crystallization temperature T_{K} of the high-temperature polymer material and below the melting temperature T_{S} of the high-temperature polymer material.

The cooling means can further have a cavity 9 that serves as a reservoir for polymer material melt. Just as the channel 8, the cavity 9 can be controllably cooled by the electronic regulating unit 11. While the polymer material melt is located inside of the cavity 9, the temperature of the polymer material melt can thus be lowered to a processing temperature T_{V} lying above a crystallization temperature T_{K} of the high-temperature polymer material and below the melting temperature T_{S} of the high-temperature polymer material.

In the exemplary embodiment shown on FIG. 1, the means 5 for additively manufacturing the three-dimensional object 2 is a 3D-print head, to which the cooled polymer material melt is fed from the cooling means 4. In particular, the polymer material melt can be conveyed via the cooling means 4 into the 3D-print head 5 by means of conveying means 10, e.g., in the form of a gear pump or reciprocating pump. In the exemplary embodiment shown on FIG. 1, a pump 10 is located in the area of the channel 8 of the cooling means 4, e.g., in an entry area of the channel 8 facing the plasticizing extruder 3. However, this position of the pump 10 is not mandatory. The pump or conveying means 10 can further be arranged at another position, from which it enables a conveying of the polymer material melt via the cooling means 4 into the 3D-print head 5 or into the means 5 for additively manufacturing the three-dimensional object 2, e.g., in an area between the plasticizing extruder 3 and cooling means 4, in an area between the cooling means 4 and 3D-print head 5, or in an area between the cavity 9 and 3D-print head 5. The 3D-print head 5 constitutes a temperature-critical system component of the device 1. The polymer material melt that is fed to the 3D-print head 5 should not exceed a fixed maximum temperature value or a temperature limit T_{L}, so as to avoid heat-induced damages to the 3D-print head 5. For this reason, the cooling means 4 or its channel 8 and/or its cavity 9 lower the temperature of the polymer material melt to the processing temperature T_{V}, which lies above the crystallization temperature T_{K} of the high-temperature polymer material and below the maximum temperature value or temperature limit T_{L} of the 3D-print head 5, wherein the polymer material melt is kept in this temperature range.

The polymer material melt does not yet solidify within this temperature range, since a solidification process only sets in once the crystallization temperature T_{K} has been reached; however, the latter is exceeded. The polymer material melt can thus be distributed in layers onto the object carrier 7 via the 3D-print head 5 in drop form, so as to manufacture or generate the three-dimensional object 2 in this way. To this end, the object carrier 7 can traverse in three mutually perpendicular directions relative to the 3D-print head 5 in a known manner. In particular, the object carrier 7 can be correspondingly traversed in a computer-controlled manner, wherein CAD data of the three-dimensional object 2 to be manufactured can be used for control purposes.

In order to especially reliably be able to prevent the polymer material melt from solidifying in the area of the cooling means 4 and/or in the area of the 3D-print head 5, the 3D-printer 1 has several temperature sensors 12 to 14, which can be arranged in the area of the cooling means 4 and in the area of the layered manufacturing means 5 in such a way that the temperature of the polymer material melt can be measured or determined. The temperature sensors 12 to 14 are communicatively connected with the regulating unit 11. The regulating unit 11 can instruct the temperature sensors to record measured temperature values. Alternatively, the temperature sensors 12 to 14 can also be configured to independently perform the temperature measurements. The temperature measurements take place during the cooling, conveying and additive manufacturing process, preferably continuously.

The temperature sensors 12 to 14 transmit determined temperature values to the regulating unit 11. The regulating unit 11 can access reference temperatures and/or reference temperature progressions, which it compares with the temperature values obtained by the temperature sensors 12 to 14. Based on the comparison, the regulating unit 11 decides in what way it will continue regulating the cooling means 4 for cooling purposes. For example, the regulating unit 11 can reach this decision drawing upon corresponding temperature regulating allocations or temperature progression regulating allocations. In each case, the regulating unit 11 regulates the cooling means 4 for cooling purposes in such a way that the polymer material melt always has a temperature of above the crystallization temperature T_{K}. It can likewise be provided that the cooling means 4 also be configured to heat the polymer material melt if the regulating unit determines that the polymer material melt is too close to the crystallization temperature T_{K} or is cooling too rapidly. In order to perform the aforementioned heating function, the 3D-printer 1 can alternatively also have corresponding heating means, which can be regulated by the regulating unit 11 in a manner similar to the cooling means 4.

The plasticizing extruder 3, cooling means 4, 3D-printing head 5, conveying means 10 and traversable object carrier 7 can each comprise their own control unit or regulating unit for their control or regulation within the meaning described above. Alternatively, a central control unit or regulating unit can also be provided for controlling or regulating the plasticizing extruder 3, cooling means 4, 3D-print head 5, conveying means 10 and traversable object carrier 7 within the meaning described above.

FIG. 2 shows how an exemplary embodiment of a method according to the present invention can be implemented with the device 1 according to FIG. 1. In a first step 100, PEEK granules previously prepared in the granule container 6, e.g., an unmodified TECAPEEK from Ensinger, is plasticized by means of the plasticizing extruder 3 above the melting temperature T_{S} of the PEEK granules at a plasticization temperature T_{P} of 360° C. to 390° C. into a PEEK plastic melt (a melting point of PEEK lies at 341° C.).

The PEEK plastic melt is subsequently cooled in a second step 200 to a processing temperature T_{V} of between 305° C. and 335° C., which lies above the crystallization temperature T_{K} of PEEK (for the aforementioned TECAPEEK type according to DSC between 290° C. and 300° C.) and below the temperature limit T_{L} of the 3D-print head 5 of the device 1. Cooling is achieved by guiding the plastic melt through the cooled channel 8 and cooled cavity 9.

In a third step 300, the melt is then fed to the 3D-print head, and the three-dimensional object 2 is built up in layers by means of the 3D-print head 5, wherein the object carrier 7 is correspondingly traversed, and the 3D-print head 5 distributes drops of the cooled plastic melt onto the object carrier 7. In an optional fourth step 400, residual plastic melt located inside of the plasticizing extruder 3, channel 8, cavity 9 or 3D-print head 5 can subsequently be removed by rinsing with neutral granules or with a neutral plastic or a suitable cleaning material (not shown).

1. A method for the additive manufacturing of a three-dimensional object out of a high-temperature polymer material, wherein the method comprises the steps of
plasticizing a high-temperature polymer material above a melting temperature (T_{S}) of the high-temperature polymer material, so that a melt arises from the high-temperature polymer material;
cooling the plasticized, high-temperature polymer material to a processing temperature (T_{V}), which lies above a crystallization temperature (T_{K}) of the high-temperature polymer material, and which lies below a permissible maximum temperature value (T_{L}) for critical device components of a device for additively manufacturing the three-dimensional object out of the high-temperature polymer material;
conveying the melt of the high-temperature polymer material cooled to the processing temperature (T_{V}) into a system for additively manufacturing the three-dimensional object; and
additively manufacturing the three-dimensional object out of the plasticized, high-temperature polymer material cooled to the processing temperature using the system for additively manufacturing the three-dimensional object.

2. The method according to claim 1, wherein the processing temperature (T_{V}) lies below the melting temperature (T_{S}) of the high-temperature polymer material.

3. The method according to claim 1, wherein the high-temperature polymer material is a polymer, polymer blend or polymer compound, which each consist of at least one partially crystalline high-temperature plastic or contain at least one partially crystalline high-temperature plastic, wherein the partially crystalline high-temperature plastic has a melting point of over 260° C.

4. The method according to claim 3, wherein the partially crystalline high-temperature plastic is a polyaryletherketone (PAEK), a polyphthalamide (PPA), a polyamide (PA), polyphenylene sulfide (PPS), syndiotactic polystyrene (sPS) or a liquid crystalline polymer (LCP).

5. The method according to claim 1, wherein
the high-temperature polymer material is a polyetheretherketone, or contains at least one polyetheretherketone,
the high-temperature polymer material is plasticized at a temperature of 345° C. to 400° C.,
the plasticized high-temperature polymer material is cooled to a processing temperature (T_{V}) of between 305° C. and 335° C.,
the melt of the high-temperature polymer material cooled to the processing temperature (T_{V}) is conveyed into a discharge unit or a print nozzle, and
the three-dimensional object is additively manufactured out of the high-temperature polymer material cooled to the processing temperature (T_{V}).

6. The method according to claim 1, wherein the high-temperature polymer material is a low-viscosity high-temperature polymer material.

7. The method according to claim 1, additionally comprising a removal of plasticized, high-temperature polymer material cooled to the processing temperature (T_{V}) after the additive manufacturing of the three-dimensional object by rinsing with a neutral plastic or a suitable cleaning material.

8. The method according to claim 1, additionally comprising an electronic regulation of cooling the plasticized, high-temperature polymer material to the processing temperature (T_{V}), wherein, during the cooling, conveying and additive manufacturing process, the temperature of the plasticized, high-temperature polymer material is monitored, and the electronic regulation of cooling is performed in such a way that the plasticized, high-temperature polymer material always has a temperature above the crystallization temperature (T_{K}).

9. A device for the additive manufacturing of a three-dimensional object out of a high-temperature polymer material, wherein the device comprises
a heating system configured to plasticize a high-temperature polymer material above a melting temperature (T_{S}) of the high-temperature polymer material;
a cooling system configured to cool the plasticized, high-temperature polymer material to a processing temperature (T_{V}), which lies above a crystallization temperature (T_{K}) of the high-temperature plastic, and which lies below a permissible maximum temperature value (T_{L}) for critical device components of the device,
a conveying system configured to convey the melt of the high-temperature polymer material cooled to the processing temperature (T_{V}) into an additive manufacturing system to additively manufacture the three-dimensional object out of the plasticized, high-temperature polymer material cooled to the processing temperature (T_{V}).

10. The device according to claim 9, wherein
the heating system is configured for plasticizing a polyetheretherketone polymer material at a temperature of 345° C. to 400° C.;
the cooling system is configured for cooling the plasticized polyetheretherketone polymer material to a processing temperature (T_{V}) of between 305° C. and 335° C.; and
the additive manufacturing system is configured to additively manufacture the three-dimensional object out of the polyetheretherketone polymer material cooled to the processing temperature (T_{V}).

11. The device according to claim 9, additionally comprising an electronic regulating unit, which is configured for electronically regulating the cooling system to cool the plasticized, high-temperature polymer material to the processing temperature (T_{V}), wherein, during the cooling, conveying and additive manufacturing process, the temperature of the plasticized, high-temperature polymer material is monitored, and the cooling system is electronically regulated in such a way that the plasticized, high-temperature polymer material always has a temperature above the crystallization temperature (T_{K}).
